(19) United States
(12) Patent Application Publication
(10) Pub. No.: US 2008/0268300 A1
(43) Pub. Date: Oct. 30, 2008

(54) Method for producing fuel and power from a methane hydrate bed using a fuel cell

(76) Inventor: William C. Pfefferle, Madison, CT (US)

Correspondence Address: Robert L. Rispoli;Precision Combustion, Inc., 410 Sackett Point Road, North Haven, CT, 06473, US

(21) Appl. No.: 12/012,398

(22) Filed: Jan. 31, 2008

Related U.S. Application Data
(60) Provisional application No. 60/926,952, filed on Apr. 30, 2007.

(51) Int. Cl. H01M 8/06

(52) U.S. Cl. 429/17; 429/19

(57) ABSTRACT

A method of producing natural gas fuel from gas hydrate beds is provided wherein natural gas is oxidized in a fuel cell producing electricity and heat. At least a portion of the heat is transferred to water and the heated water is passed downhole and brought into thermal contact with a hydrate bed. The hydrate is disassociated thereby producing hydrate gas. A sufficient amount of fuel is then passed to the fuel cell for operation of the fuel cell.

### CROSS-REFERENCE

This application claims the benefit of U.S. Provisional Application No. 60/926,952 filed Apr. 30, 2007.

### FIELD OF THE INVENTION

The present invention relates to an integrated method for the production of electrical power and natural gas from methane hydrate deposits. More particularly, the present invention is directed to the release of methane from methane hydrates using exhaust heat from a fuel cell operating on produced methane.

### BACKGROUND OF THE INVENTION

### Description of the Related Art

Methane hydrate deposits are abundant throughout the world and have been estimated to represent by far the greater portion of the world's fossil energy reserve. Within the United States alone, methane hydrates represent an estimated 200,000 Trillion cubic feet (Tcf) of the total 227,500 Tcf of known natural gas reserves. The methane hydrate deposits, occurring at great depths primarily in the oceans, dwarf the total known combined oil and non-hydrate gas reserves. With the United States largely dependent upon imported fuels, there is an urgent need for a method to economically produce natural gas from the abundant United States methane hydrate reserves. Unfortunately, it has not yet been demonstrated that methane can be economically recovered from methane hydrates. Two approaches are possible; mining and in-situ dissociation.

For in-situ dissociation, three approaches exist. One method involves heating the methane hydrate. This requires only about ten percent of the trapped gas heating value, assuming no heat losses. However, for below-ocean deposits, it has been found that pumping a heated fluid from the surface to the methane hydrate deposit results in such a high heat loss that essentially all of the heating value of the recovered methane is consumed to supply the needed energy for hydrate dissociation. Improved insulated piping can significantly reduce heat loss. Regardless, for deep deposits the heat loss in transit downhole of hot fluids from the surface is typically unacceptable. In-situ combustion would minimize such transit heat losses but would be difficult to establish in a hydrate bed. Downhole catalytic combustion offers a solution but has yet to be proven economic.

A second method for in-situ dissociation involves reducing the in-situ pressure to a value below the methane hydrate dissociation pressure. However, the dissociation energy must still be supplied to the formation. Consequently, the methane hydrate formation temperature decreases thereby requiring even lower pressures for dissociation reducing gas flow to uneconomic levels. Accordingly, this approach typically requires mining the solid methane hydrates and pumping slurry to the surface. Such a mining system has yet to be demonstrated to be economically feasible.

Another method for in-situ dissociation involves pumping carbon dioxide downhole to displace methane from the methane hydrates by formation of carbon dioxide hydrates. However, this method has not been demonstrated as feasible as the reaction is slow at the deposit temperatures. In addition, conditions in a stable hydrate bed are appropriate for the formation of new methane hydrate from methane and water. Again, it is important in this method to raise the temperature of the deposit to minimize the reformation of methane hydrates.

### SUMMARY OF THE INVENTION

It has now been found that burning produced gas in an on-site fuel cell to generate electricity generates enough waste heat to produce all the natural gas needed for the fuel cell, even with otherwise unacceptably high heat loss in transport downhole. Inasmuch as only about ten percent of the heat of combustion is needed to decompose methane hydrate, even a sixty percent efficient fuel cell liberates for use forty percent of the fuel heating value for dissociation. A seventy five percent loss is therefore acceptable to produce the natural gas fuel required.

In a system of the present invention fuel is fed to a fuel cell anode chamber and oxidant (air or high purity oxygen) is fed to a cathode chamber. In the anode chamber fuel is oxidized by oxygen transported through the cell membrane producing carbon dioxide and water. These are removed in a bleed gas stream. Heat from anode bleed gas and the hot cathode bleed stream is passed to a gas to water heat exchanger producing heated water. Note that the anode bleed gas may be mixed with oxygen or available cathode exhaust for combustion prior to heat exchange. With low available water temperature, even some of the latent heat in the exhaust gas water vapor may be recoverable. Advantageously, the heated water is passed downhole via an injection well having insulated tubing. The injection well may have multiple side branches for optimum distribution of the heated water. Liberated gas is produced through a production well.

With less efficient fuel cell operation, gas production can greatly exceed that needed for fuel cell operation. Excess gas may be delivered to market by pipeline or as Liquefied Natural Gas (LNG). Electricity produced is readily transported using state-of-the-art transmission systems. Note that electricity typically has at least triple the value of the gas consumed. For remote locations, the electrical power can be used either to liquefy gas for export as LNG or converted on-site to desired products such as diesel fuel using available technology.

Capturing the CO₂ produced is readily accomplished since the anode bleed gas contains primarily carbon dioxide and water plus uncombusted fuel. After combustion and heat recovery such CO₂ rich gas could be injected into the hydrate bed for sequestration and enhanced methane production, or delivered to an oil field to enhance oil production. Advantageously the system may include an air separation plant to supply oxygen to the fuel cell and for combustion of the fuel cell bleed gas. In this case, high purity carbon dioxide is readily recovered for injection downhole for either natural gas production or enhanced oil recovery.

### BRIEF DESCRIPTION OF THE DRAWING

FIG. 1 is a schematic drawing of a fuel production system according to the present invention.

### DETAILED DESCRIPTION OF THE DRAWING

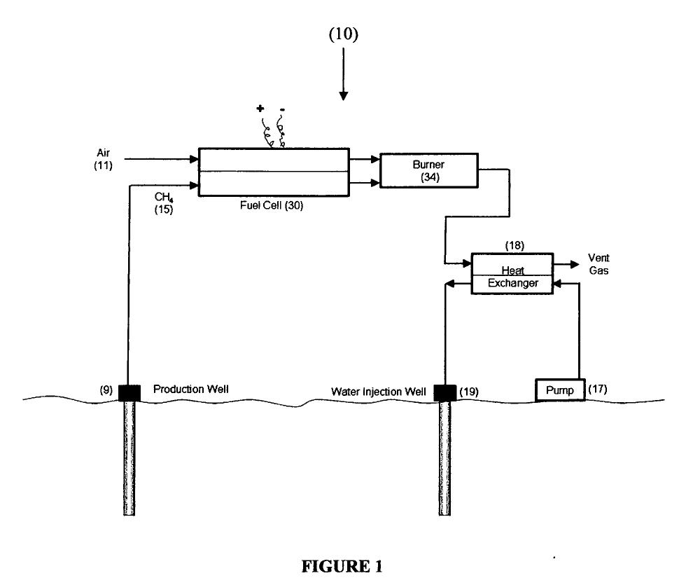

As shown in FIG. 1, a system 10 according to the present invention comprises a supply of air (or oxygen) 11 and methane fuel 15 that are fed to the cathode and anode chambers of a solid oxide fuel cell 30. Bleed streams from the solid oxide fuel cell 30 are fed to a burner 34 to recover remaining fuel values in the anode chamber fluid. The hot gas passes through heat exchanger 18 heating sea water from pump 17 before injection into a hydrate bed via injection well 19. Gas liberated by thermal decomposition of hydrate is recovered via well 9 to supply fuel cell 30. Excess gas, not shown, is exported. With an air separation plant, high purity oxygen is fed to the cell cathode increasing fuel cell performance by minimizing the blanking of the cathode by inert nitrogen.

Although the invention has been described in considerable detail, it will be apparent that the invention is capable of numerous modifications and variations, apparent to those skilled in the art, without departing from the spirit and scope of the invention.

What is claimed is:

1) A method of producing natural gas fuel from gas hydrate beds comprising:
a) oxidizing produced natural gas in a fuel cell to generate electricity and heat;
b) transferring at least a portion of the heat to water;
c) passing heated water downhole and into thermal contact with a hydrate bed;
d) dissociating hydrate and producing hydrate gas; and
e) passing sufficient fuel to the fuel cell for operation.

2) The method of claim 1 wherein the fuel cell is a solid oxide fuel cell.

3) The method of claim 1 wherein the anode bleed gas from the fuel cell is combusted to produce heat.

4) The method of claim 3 wherein the bleed gas is combusted with high purity oxygen

5) The method of claim 1 wherein both electricity and gas are exported.

6) The method of claim 1 wherein a portion of the electricity is utilized for liquefaction of produced natural gas.

7) The method of claim 1 wherein carbon dioxide is recovered from the fuel cell.

8) The method of claim 7 wherein the carbon dioxide is fed to an oil deposit to enhance oil recovery.

9) A system for recovery of energy from a methane hydrate bed comprising:
a) a solid oxide fuel cell;
b) a fuel feed for the fuel cell anode;
c) an oxidant feed for the fuel cell cathode;
d) an anode bleed for withdrawing reacted gas feed;
e) a heat exchanger to transfer heat from the fuel cell exhaust streams to water;
f) an injection well to deliver heated water to a hydrate deposit; and
g) a gas production well to deliver fuel to the fuel cell.

10) The system of claim 9 where the fuel is produced natural gas.

11) The system of claim 9 wherein the injection well is thermally insulated.

12) The system of claim 9 further comprising a separate bleed gas heat exchanger to condense bleed gas water prior to CO₂ recovery.

13) The system of claim 9 further comprising an oxygen plant to provide oxygen for the fuel cell system

14) The system of claim 12 further comprising a compressor for compressing bleed gas carbon dioxide for injection downhole for gas and or oil production.

15) The system of claim 9 wherein the injection well has multiple branches to distribute the heated water to the hydrate deposit.
